(19) United States
(12) Patent Application Publication
(10) Pub. No.: US 2016/0300453 A1
(43) Pub. Date: Oct. 13, 2016

(54) System and Method for Providing an Electronic Multiple Hand Card Game

(71) Applicant: Case Venture Management, LLC, Northbrook, IL (US)

(72) Inventor: Scott D. Slomiany, Rolling Meadows, IL (US)

(73) Assignee: Case Venture Management, LLC, Northbrook, IL (US)

(21) Appl. No.: 15/096,451

(22) Filed: Apr. 12, 2016

Related U.S. Application Data
(60) Provisional application No. 62/146,461, filed on Apr. 13, 2015.
(60) Provisional application No. 62/147,342, filed on Apr. 14, 2015.

(51) Int. Cl. G07F 17/32

(52) U.S. Cl. CPC G07F 17/3293; G07F 17/3244

(57) ABSTRACT

A system and method for providing an electronic wagering card game involving multiple hands and randomized wild jokers is described. A base game is initially dealt and at least one bonus game is dealt depending upon an initial player bet and also depending upon whether the player receives a winning hand in the base game. Wild joker cards can be randomly placed within the bonus game(s) according to joker counts contained within joker sets.

### FIELD OF TECHNOLOGY

The present disclosure relates generally to electronic wagering games and, more particularly, to an electronic wagering card game involving multiple hands which are involved in a gameplay.

### BACKGROUND

Card games abound. These games of chance typically involve the user/player playing one type of game at a time, e.g., one type of poker. Using technology, many of these games can now be simulated using a computer or mobile device. To encourage continuing use and maintain player interest in card games, particularly in a real or simulated casino game (e.g., on the Internet), the game may award the player bonus games or more simply bonus opportunities which automatically play out. The bonus effect has been found to be very attractive in the sense of drawing interest in the game itself, but also in keeping the player interested in continuing to play, including where there is an additional pay-in required in order to provide for the prospect of a bonus event.

### SUMMARY

The present disclosure describes a system and method for providing an electronic card game involving one or a plurality of bonus games having randomized wild cards that increase the odds of the player winning the bonus game(s). An aspect of the present disclosure relates to a system for providing the multiple hand card game. The system includes a player, player computer, host computer, and a wild card aspect. Sometimes the wild card aspect, which may be a plurality of wild cards (and referred to as a wild card set herein), is also referred to herein as a joker card or set; as will be seen, the joker card is used as the wild card in embodiments described (although any card could be designated as “wild”). The player may initially convey a bet amount selection to the player computer. The player computer may then transmit this bet submission to the host computer, which deals a base game to the player computer. This model may be a server based gaming environment such as internet wagering, video lottery, and social/mobile implementations (e.g., free to play or wagering versions), for example. In this type of model, the results and accounting are supervised by the host computer while the player computer presents the game(s) and results. Thus, this could all be done on a single computer platform, such as in a gaming machine found in casinos, which are well known in the art. In one form, the host computer also determines the number of bonus games covered by the player's bet, where a plurality of bonus games (rounds or events) are provided, and “deals” that amount of bonus games to the player computer, as when the player has a predetermined type of winning hand in the base game. Additionally, the host computer transmits a joker set request to the joker set database. The host computer thereby receives a selected joker set, which is randomly assigned to each bonus game according to a methodology which provides for none, one, or more joker (wild) cards to appear in the one or more bonus hands. The host computer further determines a payout for the base game and bonus game(s) and transmits any determined payout to the player computer.

As noted, aspects of the present disclosure can be provided on a single computer platform, and therefore not in a player-host arrangement, as the latter might be accomplished in an Internet environment, which might further include multiple-player action. There may accordingly be a game program which performs the functions of providing the base game, the bonus game(s), and the related functions of display, wager and other player input and registration, gameplay and payout.

Another aspect of the present disclosure relates to a method for providing an electronic multiple hand card game. The method includes receiving a bet from a player computer and dealing a base game to the player computer. Further, a base game outcome is determined and one or more bonus games are dealt to the player computer when it is determined that the player received a winning hand in the base game. Each of the bonus games in this version may be dealt from a different card deck than the base game and each other bonus game, i.e., each hand is from its own deck. Also, each card deck may include a joker set that assigns wild joker card(s) to each bonus game at random, or a single joker set that is then applied across all of the bonus game(s) that may be involved. The method further includes determining an outcome of each bonus game and determining payouts for the played base and bonus game(s). Additionally, these payouts are transmitted to the player computer.

The base game may be draw poker and the bonus game(s) may be stud poker. It should be appreciated that the present disclosure is not limited to a bonus game that is the same or similar to the base game. Also, the magnitude (i.e., number) of played bonus game(s) may be correlative with the player's bet. Moreover, the payouts for the base and bonus games may use a single paytable. Alternatively, the payouts for the base and bonus games may use different paytables and may have different pay categories. The method may further include selecting a joker set from at least two joker sets. These plurality of joker sets may have varying probability weights evidencing their likelihoods of being selected for the bonus game(s).

### BRIEF DESCRIPTION OF THE DRAWINGS

The features, nature, and advantages of the present disclosure may be further understood from the detailed description set forth below when taken in conjunction with the drawings in which like reference characters identify corresponding aspects throughout.

FIG. 1 is a system flow diagram illustrating a method for providing an electronic wagering card game according to the present disclosure.

FIGS. 2A and 2B are a process flow diagram illustrating a method for providing an electronic wagering card game according to the present disclosure.

FIG. 3 is a player computer display screen shot illustrating an electronic wagering card game according to the present disclosure.

FIG. 4 is a player computer display screen shot illustrating an electronic wagering card game according to the present disclosure.

FIG. 5 is a player computer display screen shot illustrating an electronic wagering card game according to the present disclosure.

FIG. 6 is a player computer display screen shot illustrating an electronic wagering card game according to the present disclosure.

FIG. 7 is a player computer display screen shot illustrating another electronic wagering card game according to the present disclosure.

### DETAILED DESCRIPTION OF EMBODIMENTS

An aspect of the present disclosure relates to a multi-hand card game involving a base game and at least one bonus game that is dealt when the player wins the base game. The base game may be video draw poker and the bonus game(s) may be stud poker. The number of bonus games played by the player may depend upon the decision of the player, e.g., the more the player bets the more bonus games the player may play. Each time the bonus games are dealt, wild or joker cards are randomly assigned to the bonus games. This may be according to joker sets, thereby increasing the odds the player will win. The overall gaming system described herein may be configured to achieve desired expected value (“EV”) results by the bonus game bets and the formula used for adding wild joker cards to the bonus games.

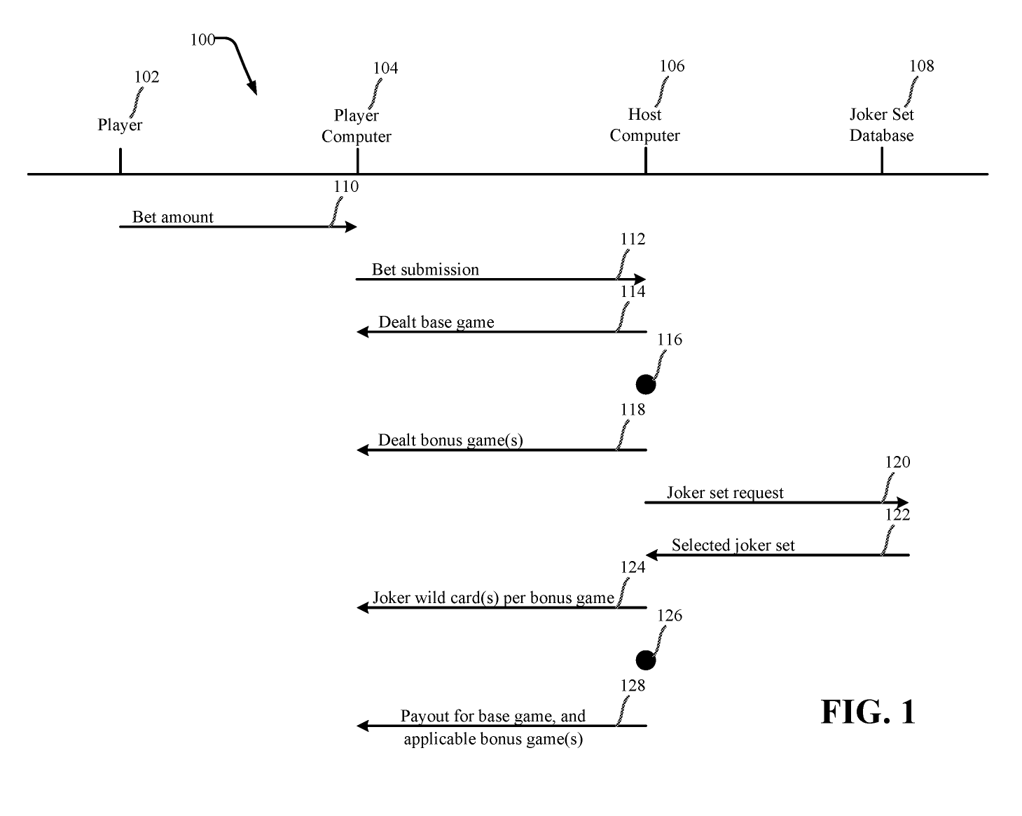

FIG. 1 illustrates a system 100 for providing an electronic wagering card game according to the present disclosure. The system 100 includes a player 102, a player computer 104, a host computer 106, and a memory (e.g., a server) including a joker set database 108. The components 104, 106, 108 of the system 100 may be in direct communication or may be in indirect communication via one or more networks.

The player 102 indicates to the player computer 104 a bet amount the player is willing to wager on the multiple hand game (illustrated as 110). The player computer 104 transmits this bet amount to the host computer 106 (illustrated as 112), which thereby deals a base game to the player computer 104 (illustrated as 114). The base game may be draw poker, for example. In a draw poker implementation, the player 102 may use interface buttons or a video touch screen of the player computer 104 to select which cards to hold and which cards to replace (i.e., discard). These selections are communicated from the player computer 104 to the host computer 106 (not illustrated). Replacement cards are selected by the host computer 106, which are then transmitted to the player computer 104 (not illustrated).

The host computer 106 determines whether the player 102 received a winning hand in the base game and further determines an amount of bonus games the player wagered to play (illustrated as 116). The bonus games may be stud poker, for example. However, it should be appreciated that other games of chance may be substituted without departing from the scope of the present disclosure, including games other than poker. When the player 102 wins the base game, the host computer 106 deals the bonus game(s) to the player computer 104 (illustrated as 118). Each bonus game may be dealt from its own deck of cards, which is distinct from that of the base game and any other bonus game. One skilled in the art should appreciate that a single deck may be used by all of the bonus games or some or all of the bonus games may use their own decks without departing from the spirit and scope of the present disclosure. For example, any winning hand in the base game may allow the bonus game(s) to be dealt. However, it should also be appreciated that the bonus game(s) may only be dealt to the player computer 104 when the received hand of the base game crosses a determined threshold or other triggering characteristic. For example, this threshold may be a payout threshold and may require the received hand to be a straight or higher in order to “wake up” (initiate) the bonus game(s) dealing function. Likewise, the threshold may be a non-paying trigger, such as the appearance of a specific card in the base game.

The amount of bonus games dealt to the player computer 104 may depend upon the player's bet amount. For example, the base game may be played for 1 credit and each bonus game may be played for 2 credits. Thus, one bonus game may be played if 3 credits are bet, two bonus games may be played if 5 credits are bet, and so on. However, a person skilled in the art should appreciate that the amount of credits needed to play the base and/or bonus games may be more or less than 1 credit and 2 credits respectively, and further should appreciate that the needed amount of credits may be cascading, i.e., each additional bonus game may be more or less than the preceding bonus game. Further, a person skilled in the art should appreciate that the number of bonus games playable by a player using a single bet are limitless.

The host computer 106 also transmits a joker set request to the joker set database 108 (illustrated as 120), which stores a plurality of joker sets. A joker set is a definition of how many jokers each of the dealt bonus games should receive. The increments of bonus games dealt to the player computer 104 may depend upon the number of joker counts within each joker set. For example, joker sets that each contain 4 joker counts may dictate that the bonus games be dealt to the player computer 104 in increments of 4. For further illustration, if joker sets containing 4 joker counts each are implemented, then 20 bonus games may be dealt at one time using 5 joker sets.

The host computer 106 thereby receives at least one selected joker set from the joker set database 108 (illustrated as 122). The number of joker sets received depends upon the number of joker counts within each joker set, and the number of bonus games dealt. For example, in the aforementioned scenario where 20 bonus games are dealt at once, the host computer 106 may receive five (5) different joker sets if each joker set contains four (4) joker counts. With this, each row of four (4) bonus games may be treated as an independent group. This is beneficial because it allows a player to be dealt a variety of different increments of bonus games at once.

The selection of the joker set(s) may occur randomly according to a corresponding weight of each joker set evidencing how frequently it should be randomly selected. This may occur through any means known in the art. Sample joker sets and their corresponding weights are illustrated as follows:

Weight: 10, Joker Set:[1,1,0,0]

Weight: 10, Joker Set:[2,1,0,0]

Weight: 10, Joker Set:[2,2,0,0]

Weight: 10, Joker Set:[1,1,1,0]

Weight: 10, Joker Set:[2,1,1,0]

Weight: 10, Joker Set:[2,2,1,0]

Weight: 8, Joker Set:[2,2,2,0]

Weight: 8, Joker Set:[1,1,1,1]

Weight: 8, Joker Set:[2,1,1,1]

Weight: 6, Joker Set:[2,2,1,1]

Weight: 6, Joker Set:[2,2,2,1]

Weight: 4, Joker Set:[2,2,2,2]

Weight: 4, Joker Set:[3,1,0,0]

Weight: 4, Joker Set:[3,1,1,0]

Weight: 4, Joker Set:[3,2,1,0]

Weight: 2, Joker Set:[3,2,2,0]

Weight: 2, Joker Set:[3,1,1,1]

Weight: 3, Joker Set:[3,2,1,1]

Weight: 2, Joker Set:[3,2,2,1]

Weight: 1, Joker Set:[3,3,1,1]

Weight: 1, Joker Set:[3,3,2,1]

Weight: 1, Joker Set:[4,1,0,0]

Weight: 1, Joker Set:[4,1,1,0]

Weight: 1, Joker Set:[4,2,1,0]

As illustrated in the aforementioned joker sets, at least two wild joker cards may be incorporated into the dealt bonus game(s). Placing these wild joker cards within the bonus game(s) increases the value of the bonus game hand, thereby giving the player 102 the benefit of potentially receiving a winning hand more often.

Each joker set contains a joker count attributable for a single bonus game. For example, the joker set [4,2,1,0] has joker counts 4, 2, 1, and 0, each for a different bonus game. The host computer 106 takes the randomly selected joker set and randomly assigns each joker count to a different bonus game dealt to the player computer 104 (illustrated as 124), thereby covering previously dealt cards with wild joker cards. Since this is performed randomly, some bonus games may receive no wild joker cards, while other bonus games may receive one or more wild joker cards. In this example, wild joker cards are assigned to random positions within their randomly assigned bonus hand. However, it should be appreciated that other methodologies may be used for joker card assignment, including those well known in the art, without departing from the present disclosure.

Additionally, the host computer 106 can determine the payout for the base game and any played bonus game(s) (illustrated as 126), and send the payout for the base game and applicable bonus game(s) to the player computer 104 (illustrated as 128). The base game may use a standard paytable as is known to those skilled in the art. For example, a standard Jacks or Better 9/6 paytable may be utilized. Moreover, traditional “max bet” bonusing may be applied to the payouts as are standard in the art. The bonus games described herein may use the same paytable as the base game; however, the bonus game paytable may include extra payouts to handle additional pay types available due to the wild joker cards. For example, the additional pay types available may include royal flush with wilds, five of a kind, and so on. An example paytable is illustrated as follows:

800 Royal Flush (with 5 or more credits bet)

250 Royal Flush (with less than 5 credits bet)

100 Five of a Kind (not available in the base game)

50 Royal Flush with Wilds (not available in base game)

50 Straight Flush

25 Four of a Kind

9 Full House

6 Flush

4 Straight

3 Three of a Kind

2 Two Pair

1 Pair of Jacks or Better

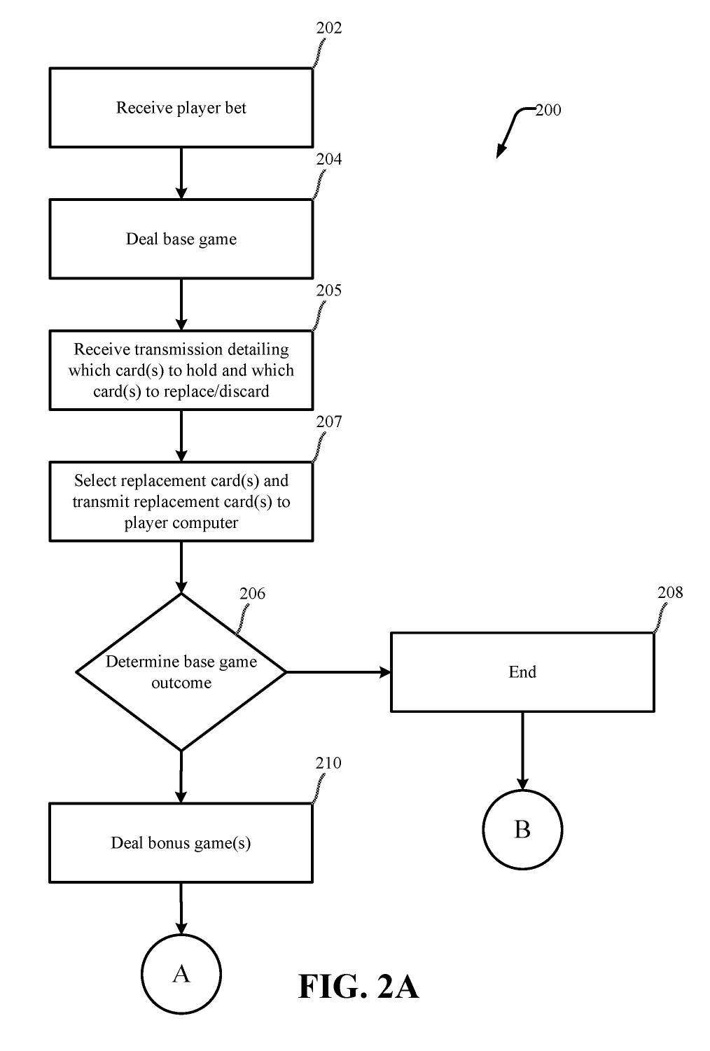

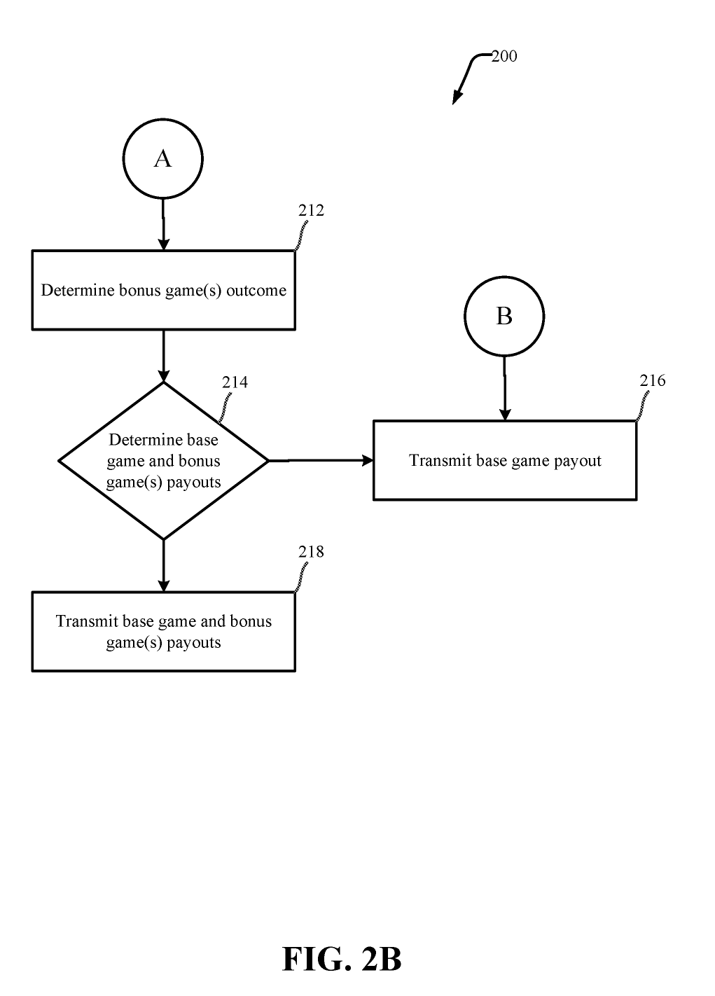

FIGS. 2A and 2B illustrate a method 200 for providing an electronic card game according to the present disclosure. A player bet is received from a player computer (illustrated as 202) and a base game is dealt to the player computer (illustrated as 204). The host computer then receives a transmission from the player computer detailing which card(s) to hold and which card(s) to replace (i.e., discard) (illustrated as 205). The host computer selects replacement card(s) and transmits the replacement card(s) to the player computer (illustrated as 207) and a base game outcome is determined (illustrated as 206). If it is determined that the base game did not meet the bonus game criteria, the game is ended (illustrated as 208) and a base game payout (if any) is transmitted to the player computer (illustrated as 216 in FIG. 2B). However, if the base game result is determined to meet the bonus game criteria, at least one bonus game is dealt to the player computer (illustrated as 210). Each bonus game may be dealt from a different card deck than the base game and each other bonus game. Further, each dealt bonus game receives a portion of a joker set, which assigns wild joker cards to each bonus game at random. The outcome of the bonus game(s) is then determined (illustrated as 212 in FIG. 2B) and payouts of the base game and bonus game(s) are determined (illustrated as 214). If there are no winning hands in the played bonus game(s), a base game payout is transmitted to the player computer (illustrated as 216). If, however, there are winning hands in the played bonus game(s), both base game and bonus game(s) payouts are transmitted to the player computer (illustrated as 218).

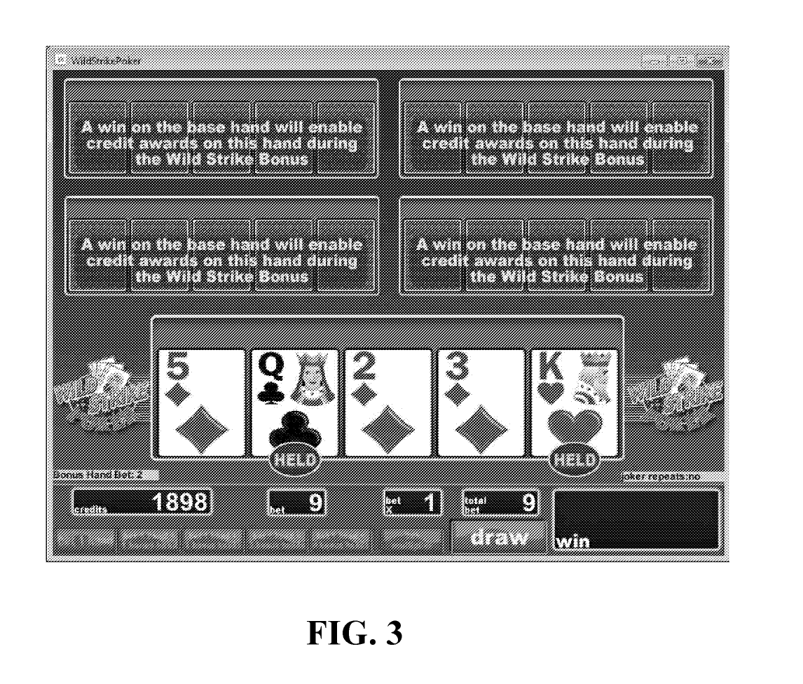

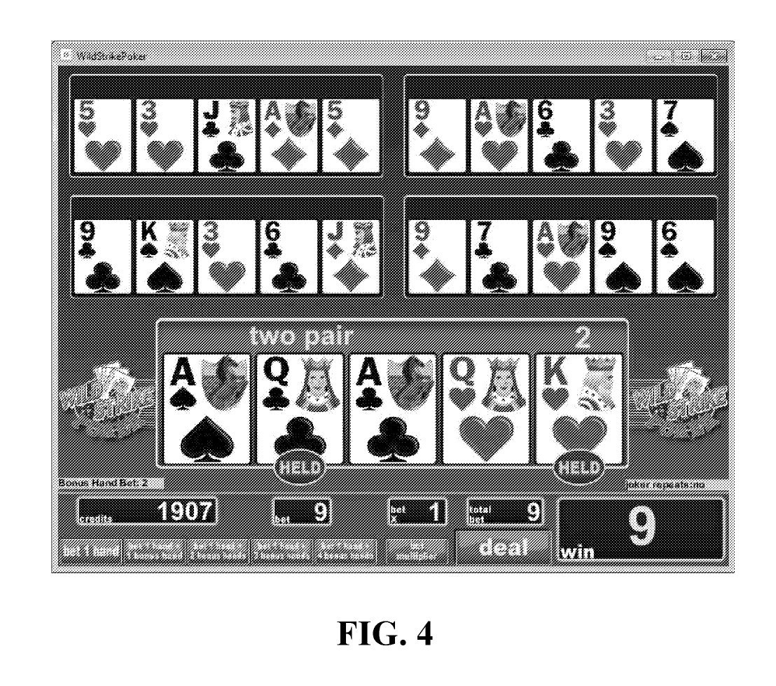

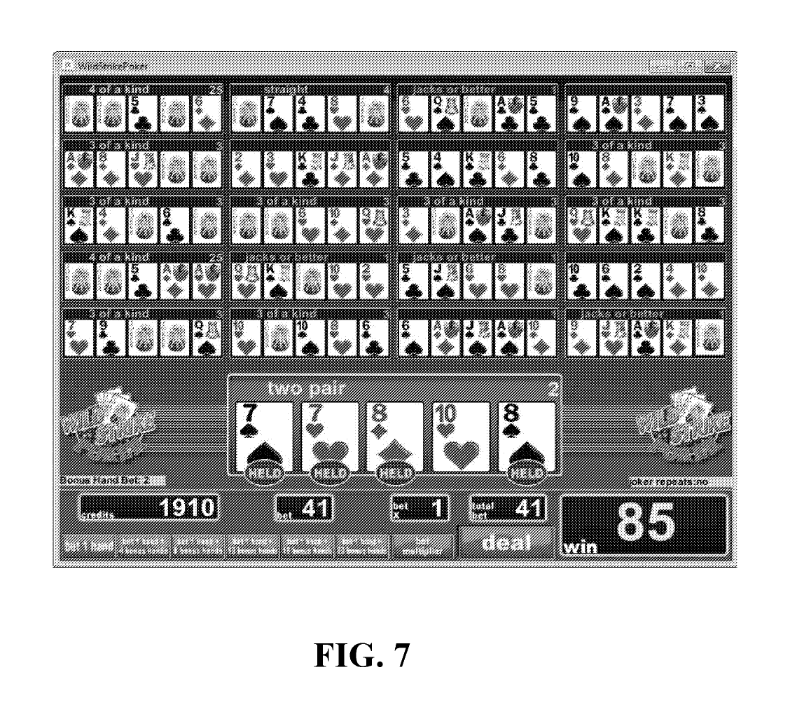

FIGS. 3-7 illustrate player computer display screenshots of the electronic wagering card game according to the present disclosure. As illustrated in FIG. 3, the multiple hand game starts with the player being dealt the base game upon wagering an amount sufficient to cover at least the base game threshold amount. The base game may be displayed to the player at or near the bottom of the player's computer display.

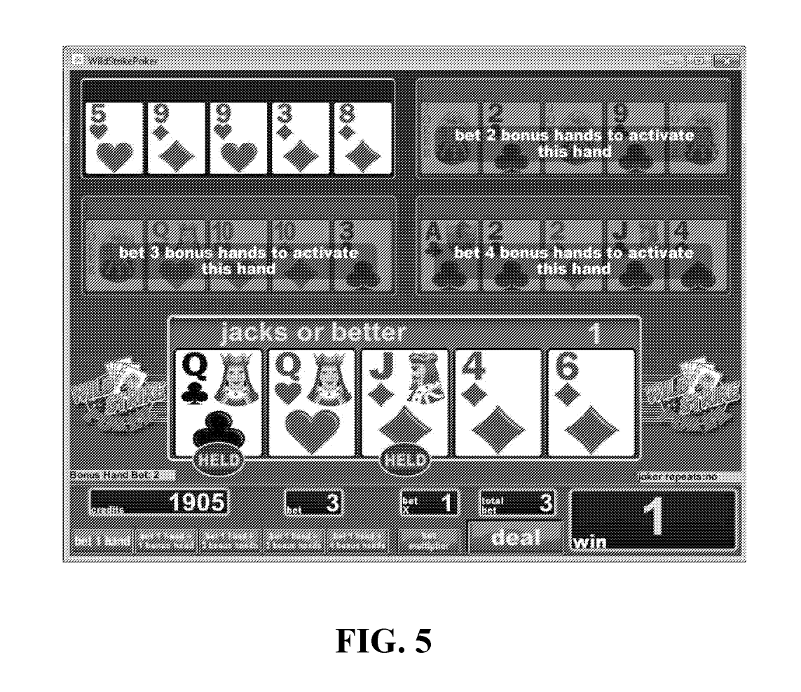

The bonus games, which in some embodiments are only dealt to the player if the player receives a winning hand in the base game, may be displayed above the base game. As illustrated in FIG. 5, these bonus games may be displayed as active or inactive based on the player's bet at the start of the base game. Thus, the amount (i.e., number) of bonus games displayed to the player prior to dealing of the base game may be more or less than the amount of bonus games to be dealt. However, one skilled in the art should appreciate that the amount of bonus games displayed to the player prior to dealing of the base game may depend upon or change according to the player's bet and/or the number of joker counts contained with the joker sets without departing from the scope of the present disclosure. While it is described herein that each bonus game may require a wager of 2 credits (e.g., in addition to 1 credit for the base hand), it should be appreciated that a single wager of any size may be used to cover a combination of base and bonus hands without departing from the present disclosure.

Multiple wild joker cards tend not be placed at the same position within a single bonus game, although the present application is not so limited. That is, in determining the random position within each bonus hand for each joker in the joker set, it may be desirable to ensure that each joker for a given hand selects a unique card position within the hand. Alternatively, multiple wild joker cards may be placed at a single spot within a single hand. Providing multiple wild joker cards at the same spot, while not necessary, may be beneficial because it provides the player with a feeling of additional wild joker cards being awarded without the dealer/host computer “having to pay for” additional jokers, i.e., without the odds of the player winning increasing.

A toggle may be provided that allows for the suppression of wild joker cards being placed on top of one another. As illustrated, this toggle may be displayed in the lower right side of a player's display above a “WIN” meter, and may illustrate the suppression described herein by stating “joker repeats: no”. Alternatively, location of the toggle may be set by the operator of the game at a location other than a lower right corner of a player's display.

As noted in FIG. 5, all bonus games may be displayed to the player, even the bonus games not being played by the player, i.e., inactive bonus games. The number of bonus games displayed to the player may be a function of the number of joker counts of joker sets used to deal the bonus games. For example, if the joker set used to deal bonus games includes 4 joker counts, then 4 bonus games may be displayed to the player even if the player wagers to play less than 4 bonus games. Moreover, all of the bonus games dealt, even the inactive bonus games, may receive wild joker cards according to the joker set. This allows for a single table containing joker sets to be utilized. Further, this has the benefit of teasing the player to increase a bet next gameplay in hopes of receiving the joker wild cards, when more bonus games are actively engaged. For example, FIG. 5 details four bonus games being displayed. These bonus games include one (1) active bonus game in which the player did not win, and three (3) inactive bonus games in which the player would have received three (3) wild joker cards in one game (resulting in a 4 of a kind) and one (1) wild joker card in another game (resulting in a 3 of a kind). For further illustration, this scenario would be denoted as the joker set [3,1,0,0].

As described herein, in some embodiments, distribution of the wild joker cards in one form is determined on an individual bonus game basis using the joker sets and joker counts. This allows the amount of wild joker cards in each bonus game to be controlled, thereby avoiding things such as an “all joker” hand, for example.

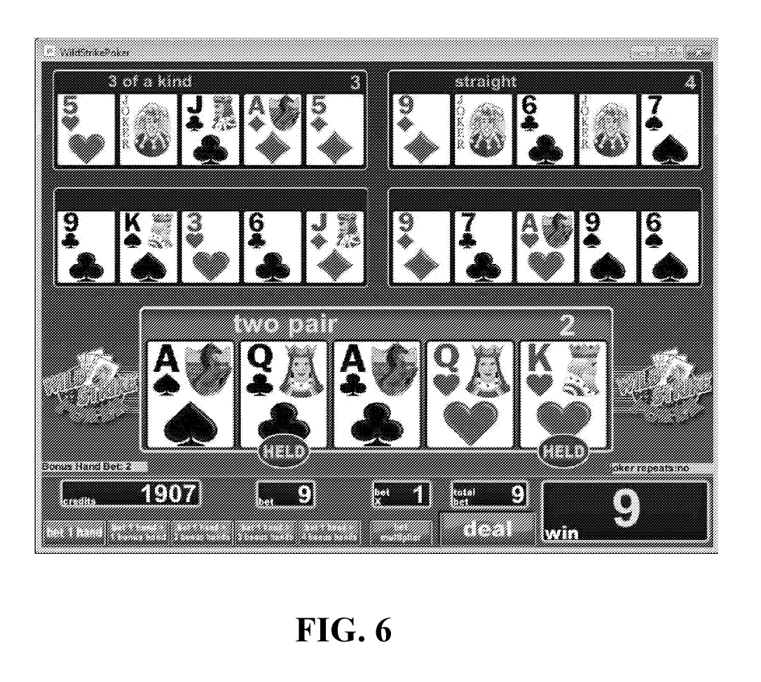

As illustrated in FIG. 6, the base game and four bonus games may be played if the player bets four bonus hands so as to activate all four bonus games. As further illustrated, a player may win the base game and a portion of the bonus games dealt. In the scenario illustrated in FIG. 6, the base hand resulted in a two pair, and the player bet four bonus games so as to play all four bonus games. In the bonus games, the player won on two of those hands, one with three of a kind and another with a straight. Both winning hands were improved by a joker, but the present invention is not so limited as to require a joker in the bonus hand.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps presently existing or later to be developed that perform substantially the same functions or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A method for providing an electronic multiple hand card game, comprising:
receiving a bet from a player computer;
dealing a base game to the player computer;
determining an outcome of the base game;
dealing at least one bonus game to the player computer when the outcome of the base game meets or exceeds a predetermined win or payout;
selecting, randomly, a joker set from a joker set database;
assigning, randomly, wild joker cards to the at least one bonus game according to joker counts of the joker set;
determining an outcome of the at least one bonus game;
determining payouts for the base game and the at least one bonus game; and
transmitting the payouts for the base game and the at least one bonus game to the player computer.

2. The method of claim 1, wherein the base game is draw poker and the at least one bonus game is stud poker.

3. The method of claim 1, wherein a number of the at least one bonus game dealt to the player computer is correlative with the player bet.

4. The method of claim 1, wherein the payouts of the base game and the at least one bonus game use a single paytable.

5. The method of claim 1, wherein the joker set is associated with a probability weight corresponding to a likelihood of the joker set being selected for the at least one bonus game.

6. A computing device in a system that provides an electronic multiple hand card game, comprising:
a device processor; and
a memory device including instructions operable to be executed by the processor to perform a set of actions, enabling the computing device to provide a base game and a bonus feature, wherein the bonus feature plays upon the existence of a predetermined condition in the base game, wherein the bonus feature operates according to a methodology that can result in a final condition constituting a win, and the methodology includes the use of a wild element subject to multiple applications in the methodology, the bonus feature comprising a plurality of independent bonus opportunities each of which has a non-zero probability of being assigned a wild element.

7. The computing device of claim 6, wherein the base game is a first card game and the bonus games are each a second card game different from the first card game.

8. The computing device of claim 6, wherein:
the joker count is equal to four; and
the number of bonus games dealt is divisible by four.

9. The computing device of claim 6, wherein the joker set includes at least two wild joker cards.

10. The computing device of claim 6, wherein wild joker cards may be placed on top of one another in a single bonus game.

11. The computing device of claim 6, wherein the predetermined trigger event corresponds to a threshold hand in a draw poker card game.

12. The computing device of claim 6, wherein the predetermined trigger event is a non-payout trigger event.

13. The computing device of claim 12, wherein the non-payout trigger event is an appearance of a predetermined card.

14. A system for playing a game with at least one bonus feature comprising:
a computational device capable of executing program commands;
a program providing a base game and a bonus feature;
the program executing a bonus feature play upon the existence of a predetermined condition in the base game, wherein the bonus feature operates according to a methodology that can result in a final condition constituting a win, and the methodology includes the use of a wild element subject to multiple applications in the methodology;
the bonus feature comprising a plurality of independent bonus opportunities each of which has a non-zero probability of being assigned a wild element;
an input device for player input to operate the system and to play the base game;
a wagering input registration for the program through which the player inputs a wager for gameplay, and a payout calculation aspect for the program to determine according to preset parameters a payout, if any, in view of a final gameplay condition.

15. A computing device in a system that provides an electronic multiple hand card game, comprising:
a memory device adapted to store data including program instructions;
a processor operable to perform the program instructions to enable the computing device to provide a base game and a bonus game;
the base game being a first game of chance;
the bonus game being a second game of chance enabled by a condition in the first game of chance, the bonus game involving elements contributing to a win or loss of a user,
the elements including a bonus element that is provided at random based on a plurality of independent bonus opportunities, wherein the bonus element improves the chances of obtaining a win for the user.

16. The computing device of claim 15, wherein the bonus element is selected from a joker set having at least two wild joker cards.

17. The computing device of claim 16, wherein the wild joker cards may be placed on top of one another in the bonus game.

18. The computing device of claim 15, wherein the condition corresponds to a threshold hand in a card game.

19. The computing device of claim 15, wherein the bonus game is caused by a win in the base game and an additional wager to enable the bonus game.

20. The computing device of claim 19, wherein the additional wager is higher if the user selects multiple bonus games.
